(19) United States
(12) Patent Application Publication
(10) Pub. No.: US 2014/0098008 A1
(43) Pub. Date: Apr. 10, 2014

(54) METHOD AND APPARATUS FOR VEHICLE ENABLED VISUAL AUGMENTATION

(71) Applicant: FORD GLOBAL TECHNOLOGIES, LLC, Dearborn, MI (US)

(72) Inventor: David Anthony Hatton, Berkley, MI (US)

(73) Assignee: FORD GLOBAL TECHNOLOGIES, LLC, Dearborn, MI (US)

(21) Appl. No.: 13/644,779

(22) Filed: Oct. 4, 2012

(51) Int. Cl. G09G 5/00

(52) U.S. Cl. 345/8

(57) ABSTRACT

A vehicle computing system includes a processor configured to communicate with a driver wearable display. The vehicle computing system may communicate and receive data from one or more subsystems within the vehicle. Once the data has been received, the vehicle computing system may analyze and prepare the data to be transmitted as a graphical message to the driver wearable display unit. The graphical message displayed to the driver may include, but is not limited to, navigation instructions, mobile device information, and vehicle instrument data. The displayed message to the driver is formatted to appear so as not to significantly interfere with a driver's road-view and may overlay on real world objects.

### TECHNICAL FIELD

The illustrative embodiments generally relate to methods and apparatuses for vehicle enabled visual augmentation.

### BACKGROUND

Modern advances in vehicle computing technology provide many entertaining and useful features for a current vehicle operator, known as a driver. From on-demand radio to turn-by-turn directions, today's driver can access useful computing and data solutions. Wearable visual aid products provide avenues of information presentation to a driver. Prior art wearable systems and methods for visual augmentation includes the following.

VUZIX has produced a usable visual aid technology called SMART glasses. The SMART glasses projects virtual images from an image generator to an eyebox within which the virtual images can be seen by a viewer. The sunglass-style eyewear can display 2D and 3D video with a virtual 67-inch screen as seen from ten feet. The eyewear can connect to all NTSC or PAL audio/video devices with video-out capabilities and composite video connections. The eyewear can also connect, with the use of an adapter, to a desktop PC, a laptop, iPod, iPhone, or iPad devices.

U.S. Patent Application 2010/0315720 generally discloses a wearable system that presents one or more heads-up displays to the wearer. A data source provides information to an image generator that is sufficient to generate one or more display images, which are still or moving, characters or graphical displays. The output image from the image generator passes through a lens, reflects off a curved mirror, and passes back through the lens the other way. The image then passes through two lenses, between which an intermediate image exists. The image reflects off the “lens,” or visor, of the glasses and proceeds to the pupil of the wearer's eye. Alternative embodiments use a helmet visor, mirror, or other (at least partially) reflective surface for the final reflection.

U.S. Pat. No. 8,203,502 generally discusses systems, methods, and devices for interfacing with a wearable heads-up display via a finger-operable input device. The wearable heads-up display may include a display element for receiving and displaying display information received from a processor, and may also include a wearable frame structure supporting the display element and having a projection extending away from the display element. The projection may be configured to secure the heads-up display to a user's body in a manner such that the display element is disposed within a field of view of the user. A finger-operable input device secured to the wearable frame structure is configured to sense at least one of a position and movement of a finger along a planar direction relative to a surface of the input device, and to provide corresponding input information to the processor.

U.S. Patent Application 2010/0253918 generally discusses a method to display an infotainment graphic upon a surface that is within a vehicle. The display includes monitoring a source of infotainment content and determining the infotainment graphic based upon monitoring the source of infotainment content. The displaying of the infotainment graphic is upon the surface including a material reactive to display graphics in response to an excitation projector, wherein the excitation projector includes an ultraviolet projector.

### SUMMARY

In a first illustrative embodiment, a processor operably programmed and configured to receive information from one or more vehicle modules. Once the information is received, the processor may determine which information is displayed to a driver based on predefined thresholds and/or configurations done by the driver using a user input interface. The processor may process the information into a format suitable for display to a driver through a wearable heads-up display device including eyeglasses. The processer may communicate processed information to a transceiver for wireless communication to one or more eyeglasses for display.

In a second illustrative embodiment, a pair of eyeglasses comprising a processor that includes a communications circuit, memory, user input interface selector circuit, a measurement sensor and an LCD driver display. The communications circuit configured with the processor is for receiving and transmitting data to and from a vehicle computing system to the eyeglasses. Once the eyeglasses receive the data, one or more display elements may be configured to display information from the processor to one or more lenses on the pair of eyeglasses.

In a third illustrative embodiment a computer-implemented method includes a non-transitory computer-readable storage medium storing instructions, which, when executed by a vehicle computing system, cause the system to transmit a message to a driver wearable display unit. The exemplary method performed by the processor includes receiving one or more input controls while having interaction with the vehicle computing system. Once the input data has been received, the processor may analyze the data from at least one vehicle subsystem and prepare a message based on analyzed vehicle subsystem data. After analysis, the computer program may transmit the message to be displayed on the driver wearable display. The computer program may format the message to the driver wearable display. In at least one embodiment, the message is formatted so as not to significantly interfere with a driver's road-view.

### BRIEF DESCRIPTION OF THE DRAWINGS

FIG. 1 is an exemplary block topology of a vehicle infotainment system implementing a user-interactive vehicle information display system;

FIG. 2A shows an example embodiment of a smart lens eyewear integrated with a vehicle computing system;

FIG. 2B shows an example embodiment of a smart lens eyewear circuit;

FIG. 3 is a flow-chart illustrating an example method of providing input to a smart lens eyewear device;

FIG. 4 is a flow-chart illustrating an example method of a turn by turn navigation sequence;

FIG. 5 shows an example embodiment of a smart lens eyewear integrated with a vehicle computing system with a vision system;

FIG. 6 is a flow-chart illustrating an example method of priority messaging to be displayed on a smart lens eyewear.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Various technologies may be utilized to display information to a vehicle driver from a vehicle computing system (VCS). A VCS may display information by utilizing an instrument panel, a gauge, or a “heads-up” display (HUD). A HUD can be incorporated with the VCS by projecting information onto a windshield in front of a driver or can be worn by the driver with a pair of smart lens eyewear technology including goggles, eyeglasses, a headband, a helmet, or other such device that the driver can wear. A HUD is typically positioned near the driver's eyes and calibrated and/or aligned to the driver's field of view to allow the driver to review displayed information with little or no head movement. The display may also be transparent or translucent, allowing the driver to view and interact with the surrounding environment while viewing or wearing the HUD, and so as not to interfere or at least significantly interfere (i.e., the driver can still drive and function safely) with a driver's view of the road. In at least one other non-limiting example, some of all of the data displayed on the HUD may be limited to display around or near the edges of the HUD, providing the driver with an unobstructed road-view through the display in the center of the HUD.

In some cases, the display may not be transparent, but may highlight a captured image of the environment on the display. In this case, the driver's view of the road is still “unobstructed,” even though the highlighting may appear in a central portion of the display, because the object corresponds to a real world object and thus any obstruction would already be present. In other cases, the display may be formed directly on a driver's retina via a low-powered laser scanning technique. To generate display information such as transparent or translucent images and text that interact with a surrounding environment, a vehicle computer processing system integrated with a smart lens eyewear device may be used. Such heads-up displays have a variety of applications not limited to vehicle computing systems, such as aviation information systems, mobile device systems, and video games, among others.

For example, in mobile device systems, display information may include, but not limited to text messages, weather information, emails, and other mobile applications. Mobile device display information may also include navigation data using Global Positioning System and cameras to indicate to the user turn by turn directions to their destination.

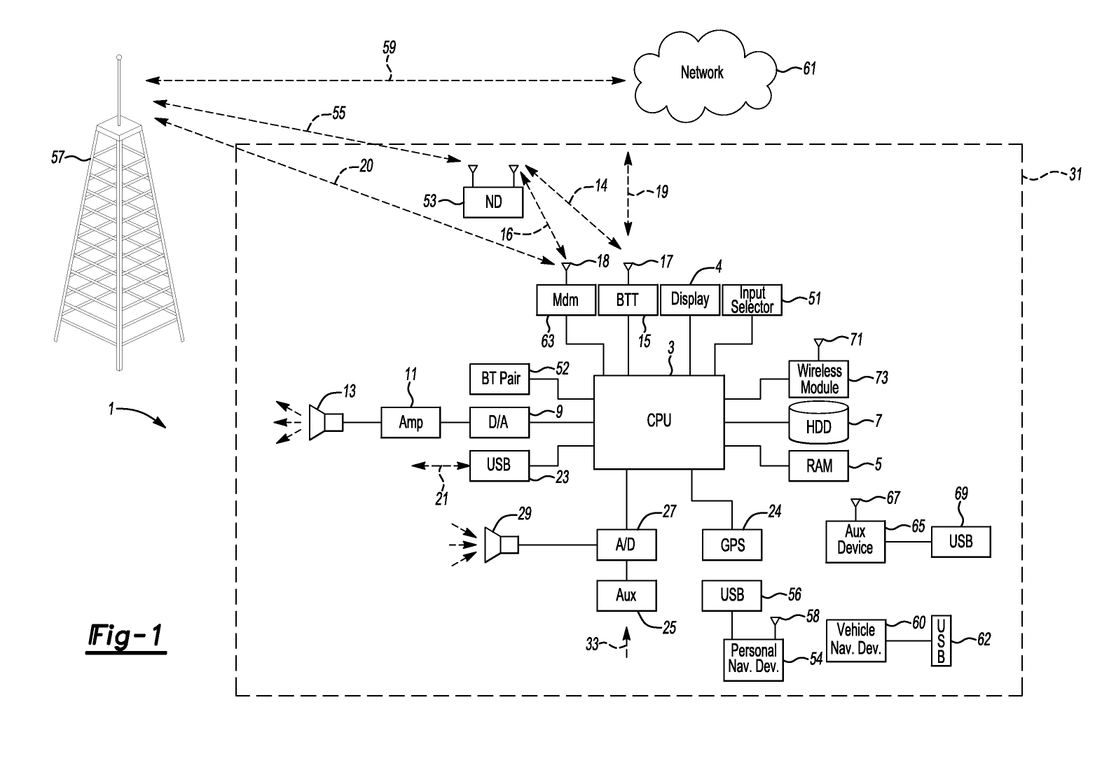

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data- plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

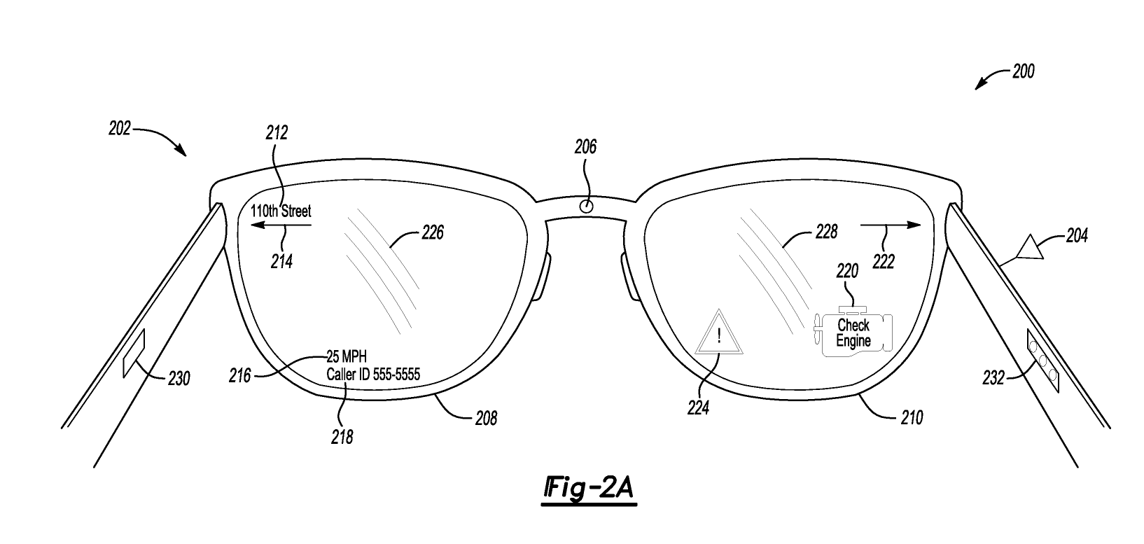

FIG. 2A illustrates an exemplary embodiment of a wearable heads-up display in the form of a smart lens eyewear system 200 integrated with a vehicle computing system. It should be noted that the information transmitted to a smart lens eyewear in FIG. 2A is not limited to what is disclosed in this illustrative example and that VCS information or other vehicle modules and systems information being delivered to the driver can be configured for display on the smart lens eyewear device 202. The smart lens eyewear device may be, but not limited to, a pair of eye glasses used as sun glasses, prescription glasses, and/or driving glasses with features like auto-dimming lenses, designed for integration with a VCS. Other devices that could be compatible with the embodiments disclosed herein may include, but not limited to, head mounted miniature screen, pico projection, dashboard mounted device providing heads up display capability, which may or may not be in communication with a driver wearable motion detector, ect. It should also be noted that the driver may limit the amount or activity of information that may be displayed on the smart lens eyewear device 202. The VCS may also limit the amount or activity of information being transmitted to the smart lens eyewear device 202 in certain situations. As shown in FIG. 2A, a smart lens eyewear system 200 may include smart lens eyewear device 202 coupled to a VCS via wired link, for example, a parallel bus or a serial bus such as a Universal Serial Bus (USB). A wireless link connection 204 may include, for example, a BLUETOOTH connection or a WiFi connection to the VCS. The connection may function to transmit data and/or commands to and from the smart lens eyewear device 202 to the VCS. The smart lens eyewear system may provide data received from camera 206 or motion sensor 230 to the VCS for processing a message to transmit to the smart lens eyewear for graphic display on respective eyewear lenses 208 and/or 210. The VCS may be configured to receive driver input defining driver instructions for controlling one or more functions of the vehicle. In response to the driver input, the VCS may be configured to present to the smart lens eyewear 200 displays of vehicle function identified by graphics in the eyewear lenses 208 and/or 210.

An illustrative embodiment of projected transparent or translucent displays in the smart lens eyewear device 202 may include, but not limited to: navigation address or street name highlight feature 212, navigation turn by turn feature 214 and 222, vehicle speedometer 216, caller identification 218, vehicle diagnostic messages 220, vision system object detection notice 224 and virtual images 226 and 228 that overlay on the real world.

Another exemplary embodiment of the smart lens eyewear device 202 display data may, for example, without limitation, enlarge text, highlight addresses or street names, or overlay a virtual address over a structure to easily identify a navigation destination received from the VCS. In FIG. 2A the data transmitted to and received from the smart lens eyewear device 202 may improve driver focus by displaying information as a tool for minimizing the potential for visual-manual interaction while the vehicle is in motion. Using one or a combination of, a camera 206, navigation device or global positioning system data may be sent to the smart lens eyewear device 202 suggesting driver maintain line of sight on the road at all times. The smart lens eyewear device 202 may recognize incoming real world images through a camera 206 and apply information such as street addresses, business names, and highway numbers in the distant field of focus. Once the VCS processes the camera 206 data, it can use this information with the navigation turn by turn feature 214 and address and/or street name highlight 212, providing the driver information so that their eyes may continue to focus on the road instead of looking at the navigation screen.

Vehicle speed is usually presented in an instrument panel located on a dashboard in most vehicles. For a driver to monitor their speed, they may take their eyes off the road to view the speedometer in the instrument panel. The driver may also be looking for posted speed limit signs when driving in an unfamiliar place. As shown in FIG. 2A, an exemplary example of the smart lens eyewear device 202 notifying the driver of vehicle speedometer 216 with a color indication if the driver is within the speed limit. An example of using color indication with speedometer information would be to have the traveling speed display in green when within the speed limit, in yellow when below the posted speed limit or in red when exceeding the speed limit. This is another illustrative example of where the smart lens eyewear device 202 may encourage the driver to maintain line of sight on the road.

Another example of minimizing driver visual-manual interaction with nomadic devices includes mobile cell phone use. Typically when a driver gets a phone call while operating their vehicle, they usually have to look down at either their mobile cell phone or if their vehicle is equipped with BLUETOOTH technology they can view the telephone number on either an infotainment display or instrument panel. Either way the driver may remove their eyes from the road to view who is calling. In FIG. 2A an exemplary embodiment is shown to have caller identification 218 displayed on the eyewear lens 208 letting the driver know who is calling without removing their line of sight off the road.

The smart lens eyewear device 202 may include a movement sensor 230 that may be provided on or in the frame for measuring driver orientation to determine the activity or amount of information that may be sent to the driver. The movement sensor 230 may include, but not limited to the use of an accelerometer, a magnetometer, or a gyroscope, among other options. An accelerometer may measure acceleration in a single and multi-axis model to detect magnitude and direction of the driver's orientation. A magnetometer is a measuring device used to measure the strength or direction of magnetic fields, and thus used to detect driver's orientation. A gyroscope is a device for measuring or maintaining orientation based on the principles of angular momentum which can also be used to detect the driver's orientation. The movement sensor 230 can be used as an input when determining the amount or activity of information being transmitted to the driver by measuring how much the driver is turning or moving their head. An alternative to determine head position and orientation of driver may be with the integration of an external dash mounted position system. The external dash mounted system may include, but not limited to, the use of a camera, infrared projector, and/or a processor that may track the movement of objects. The external dash mounted position system may transmit data to the VCS or smart lens eyewear device for determining the amount or activity of information being transmitted to the driver. If it is determined that the driver may be overstimulated, the VCS may limit messages sent to the smart lens eyewear device 202.

Other exemplary features on the smart lens eyewear device may include an input interface 232 allowing the driver to select the amount of information to be displayed. The input interface 232 will give the driver options on what information to present and the configuration of the images displayed on the smart lens eyewear device 202. The user input interface 232 may provide custom settings to allow a driver to change displays based on the experience level or age of the driver. The input interface may also provide user settings including, but not limited to, the brightness of text displays, text font size, or an on/off button.

As shown in FIG. 2A, the smart lens eyewear lenses 208 and 210 are transparent to allow virtual images 226/228 to be seen interposed with real world objects. The VCS will be able to transmit navigation device, global position system, or any other road information system data to inform the driver with virtual images 226 and 228. An example of the type of virtual images 226 and 228 includes highlighting real world road with a highly visible virtual overlay, so that it is clear to the driver where their turn is. Another illustrative example may be a road hazard the camera 206 has detected that the driver is unable to see. The VCS may communicate this to the driver by using a virtual image 226 and 228 to highlight the hazard.

FIG. 2B is an exemplary embodiment of a smart lenses eyewear circuit 234. The circuit 234 may be embedded within the frames of the smart lenses eyewear device 200. In a basic configuration as shown in FIG. 2B, the circuit 234 may typically include one or more central processing units, or controllers 236 and system memory 238. The circuit's power source 242 may be provided by a battery or power cord. The memory 238 may be volatile memory (such as RAM), non-volatile memory (such as ROM), EEPROM, flash memory, or any combination thereof. The memory may store algorithms arranged to control and interface with input and output devices including but not limited to a user input interface 232, measurement sensor 230, communications circuit, and a display driver 248. The communications circuit may include a transceiver 240 configured such that the smart lens eyewear device may connect to the VCS through a wireless connection 204, including but not limited to, a BLUETOOTH connection or a WiFi connection to the VCS. The connection 204 may function to transmit data and/or commands to and from the smart lens eyewear device 202 to the VCS. The circuit may allow the smart lens device to receive data from the VCS and display elements and images to the driver using the CPU 236 configured with a Display Driver 248. The display driver may be, but not limited to an LCD display driver 248 transmitting images to the smart lens eyewear lens.

As shown in FIG. 2B, the LCD display driver 248 may include, but not limited to, a liquid crystal (LC) panel, a light guide plate under the LC panel, and a light source within the smart lens eyewear lenses. The display driver may be configured to display elements and images on the lens of the smart lens eyewear device with the use of a plurality of scanning lines and light emitting diodes (LEDs) providing luminance upon the LC panel. The VCS may transmit data to display an image to the driver with the use of the smart lens eyewear circuit 234 and the display driver 248.

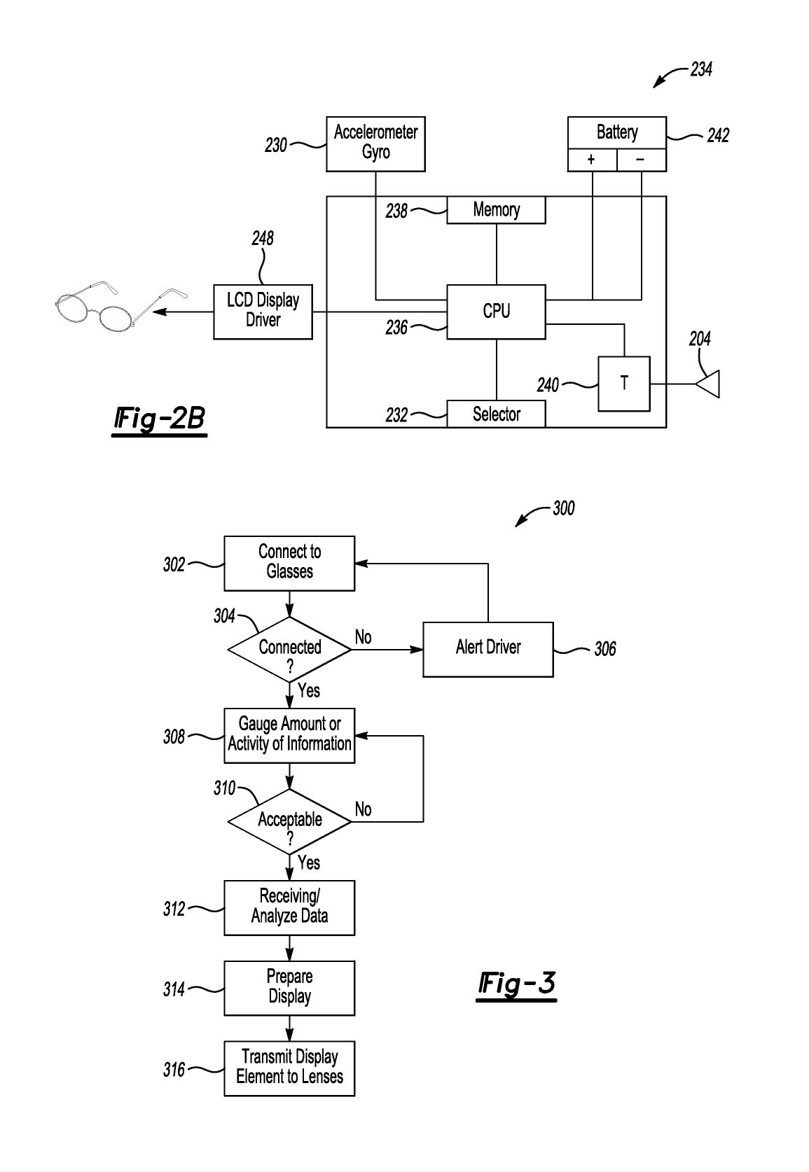

FIG. 3 is a flow-chart illustrating a non-limiting example for a method 300 of providing vehicle computing system data to a smart lens eyewear device. An example of the messages being generated and sent from the VCS to the smart lens eyewear display includes, but not limited to, personal navigation device, caller identification, vehicle diagnostic messages, vision system object detection notice, virtual images that overlay on the real world, and other driver notification messages. For example the vehicle diagnostic messages graphical display may be enabled on the smart lens eyewear device to notify a driver of a corrective action that may need to be taken when the VCS detects a fault in one of the vehicle modules or systems and transmit it to the smart lens eyewear device. The method 300 includes a connection of the smart lens eyewear device with the VCS so that data may be sent between the device and system. The method 300 includes smart lens eyewear connection 302, gauge amount or activity of information 308, receiving data from the VCS 312 and transmitting the display to the smart lens eyewear 316.

At step 302, the smart lens eyewear is turned on and ready for connection with the VCS. The VCS can connect with the smart lens eyewear through BLUETOOTH input, WiFi, USB or other suitable connections. The VCS will determine if the smart lens eyewear is connected 304. If the smart lens eyewear is not detected, the VCS may alert the driver 306, and the system may re-check for a signal to try and connect VCS to the smart lens eyewear 302. If the smart lens eyewear is connected, the system may gauge amount or activity of information 308 being transmitted to the driver.

At step 308, the VCS may gauge amount or activity of information being sent to the smart lens eyewear device by monitoring driver interface with other devices connected to the VCS including, but not limited to, nomadic devices, personal navigation device, visual front end interface, and other adjusting input gauges available to the driver. The VCS may also look at the measurement sensor located on the smart lens eyewear to determine the driver's head orientation. When determining amount or activity of information sent to the driver, the VCS may look at either the predefined thresholds of the system and/or the settings selected by the driver. If it is determined that it is not acceptable 310 to transmit information to the smart lens eyewear device based on amount or activity of information, the VCS may continue to monitor and gauge amount or activity of information before transmitting data to the driver. Once it is determined that the amount or activity of information is at an acceptable level 310, the VCS may receive and analyze data 312 from other systems or devices in the vehicle that may request to display a message to the driver.

At step 312, once the VCS verifies that amount or activity of information is acceptable, the VCS may continue to retrieve the data from other systems or devices in the vehicle including, but not limited to CAN Bus data. The VCS may receive CAN Bus data for analysis and prepare a display message 314 to be sent to the smart lens eyewear device. The data may include, but is not limited to, diagnostic messages, vision system object detection notice, navigation device instructions, detection of a road hazard, vehicle speed, and nomadic device information including mobile cell phone incoming caller ID.

At step 314, once data has been retrieved and processed by the VCS 312, the vehicle computer may prepare to transmit the display message 314 to the smart lens eyewear device. The message can be displayed in a number of transparent or translucent images on the smart lens eyewear lenses including, but not limited to, virtual displays, highlighting address or street, check engine light symbol when a vehicle diagnostic is set, text of name or phone number for Caller ID, and navigation turn by turn arrows. The images may interact or overlay with the real world having structures, address or street names highlighted or enlarged.

At step 316, once the display has been prepared by the VCS 314, the display message may be sent to the smart lens eyewear lenses of the smart lens eyewear device. Based on the type of display, the image may be visible to the driver until an action has been complete or for a predetermined set of time. For example, if the display is a turn by turn navigation instruction, the arrow to turn may be displayed until the driver enables a turn signal or the vehicle gets within ten feet or less of a turn. It must be noted that the VCS may always be monitoring amount or activity of information and determine if displays should be disabled based on guidelines of the system that may be predefined thresholds and/or selected by the driver. Another example of how long a display may be viewable to the driver is the caller ID feature, once the driver answers the mobile device, or ignores the call, the Caller ID display may adjourn.

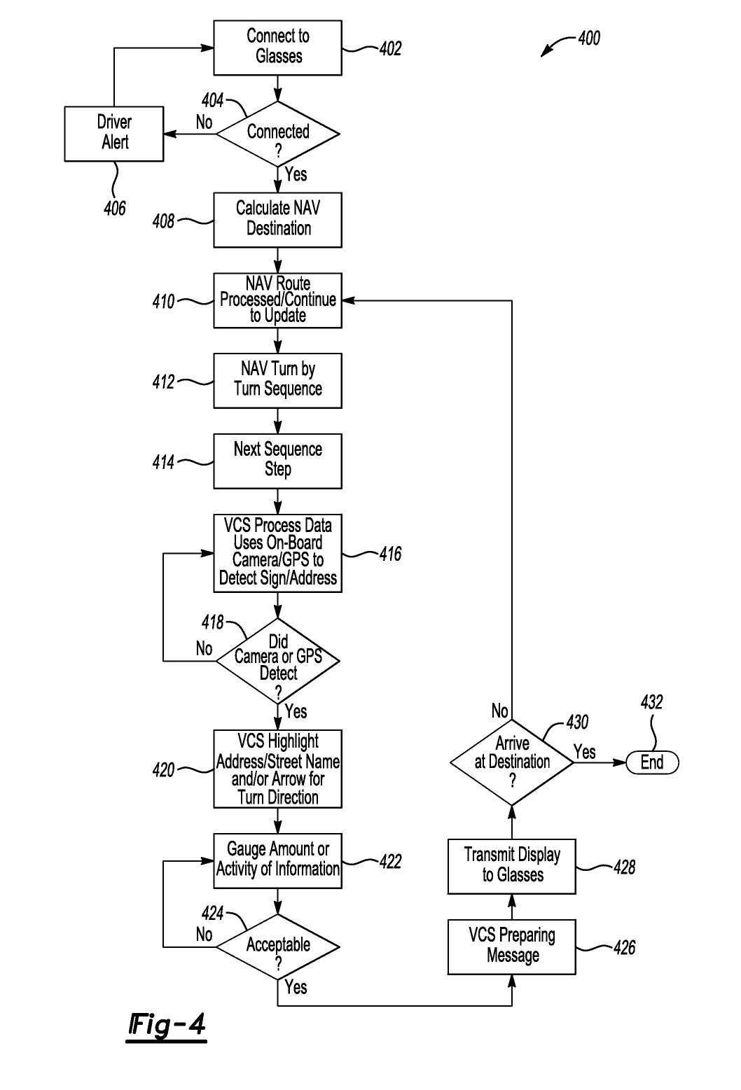

FIG. 4 is a flow-chart illustrating an exemplary example method of a turn by turn navigation sequence using a smart lens eyewear method 400. The method 400 includes a connection 402 of the smart lens eyewear device to the VCS, turn by turn directions in sequential steps 414, use of on-board cameras and/or GPS to detect address, street name or structure 416, highlight detected address, street name and/or display arrow 420, while gauging amount or activity of information 422 before VCS prepares 426 and transmit display message 428 to the smart lens eyewear device.

At step 402, the smart lens eyewear is turned on and ready for connection with the VCS. The VCS can connect with the smart lens eyewear through BLUETOOTH input, WiFi, USB, or other suitable connections. The VCS may determine if the smart lens eyewear is connected 404. If the smart lens eyewear is not detected, the VCS may alert the driver 406, and the system may re-check for a signal to try connecting 402 VCS to the smart lens eyewear. If the smart lens eyewear is connected, the device may start communication with the VCS.

At step 408, the navigation destination coordinates are calculated in the personal navigation device or vehicle navigation device to a planned route for the driver to follow. While driving, the navigation route is processed and updated 410 to continuously inform the driver of their location. The route may vary based on many factors including, but not limited to, road construction, whether a driver misses a turn, or a traffic detour. The navigation system may work with other systems including but not limited to VCS, GPS, or other nomadic devices to determine elected route based on varying factors.

At step 412, the navigation device processes the destination coordinates based on a turn by turn sequence the driver may take for arriving to a destination. The turn by turn navigation directions may be updated as the driver continues en route to a destination, therefore the next step may be processed once the prior step is complete, for example. Once a step is processed by the navigation device it is sent to the VCS for updating the data to the next sequential step 414. The VCS may further analyze the navigation step using a camera and/or GPS coordinates to detect an address, street name, or structure 416. For example, a vehicle camera may scan for a building address, street sign or other relevant object/structure in order that a virtual representation or enhancement of the real life object may be provided.

At step 418, the VCS may gather additional information from the smart lens eyewear camera or GPS to detect certain information, including but not limited to address, street names, highway numbers, business name or structures. The camera or GPS may detect information to further assist the driver by sending that information to the VCS for further analysis 416. Based on additional camera or GPS information, the VCS may provide a message display to the smart lens eyewear highlighting a detected address, street name and/or display arrow 420 to notify the driver of certain landmarks that makes it much easier to find a destination. Before the smart lens eyewear can receive this data, the system may gauge amount or activity of information 422.

At step 422, the VCS may gauge amount or activity of information being transmitted to the smart lens eyewear device by monitoring driver interface with other devices connected to the VCS including, but not limited, to nomadic devices, personal navigation device, visual front end interface and other adjusting input gauges available to the driver. The VCS may also look at the measurement sensor located on the smart lens eyewear to determine the driver's head orientation. If it is determined that it is not acceptable to transmit the display the system may continue to monitor amount or activity of information until it is acceptable 424 for smart lens eyewear to receive VCS data. Various methods of determining amount or activity of information levels are known and are outside the scope of this invention. Any suitable methods may be used to provide safe results in accordance with the illustrative embodiments.

At step 426, if the VCS may determine that amount or activity of information is at an acceptable level, the process may prepare the data message for transmission to the smart lens eyewear. The data may include, but not limited to, arrows to indicate to driver which way to turn, highway number, enlarged street names, addresses or business names and alert messages of traffic information.

At step 428, once data has been processed by the VCS, it may be sent to the smart lens eyewear where the device may display the data. The data can be displayed in a number of transparent or translucent images on the smart lens eyewear lenses including, but not limited to, highly visible virtual overlay highlighting address or street, enlarging an address or street name, and/or navigation turn by turn arrows. The images may interact with the real world by having structures, address or street names highlighted or enlarged to keep the drivers focused on the road.

Once the display has been prepared and transmitted 428, the display element may be sent to the lenses of the smart lens eyewear device. Based on the type of display, the image may be visible, for example, to the driver until an action has been complete or for a predetermined set of time. For example, if the display is a turn by turn navigation instruction, the arrow to turn may be displayed until the driver enables a turn signal or the vehicle gets within ten feet or less of a turn. It must be noted that the VCS may be monitoring amount or activity of information and determining if displays should be disabled based on predefined thresholds and/or set by the driver.

At step 430, the VCS may determine if the driver has arrived at the destination requested. If the driver has not arrived at the destination then the navigation route may be processed and continue updating 410 while following steps 410 through 432 until the driver has arrived at the destination processed by the navigation device.

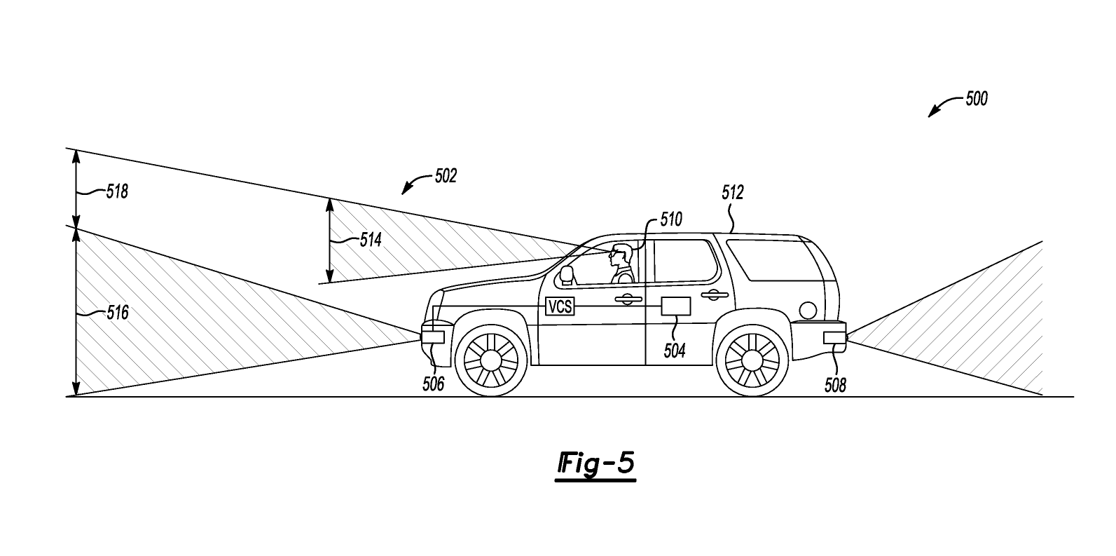

FIG. 5 illustrates an exemplary embodiment 500 for using the smart lens eyewear integrated with a vision detection system 502 to increase the field of view for a driver 510 in a vehicle 512. The vision detection system 502 may include, but is not limited to, a forward facing camera 506, a rear facing camera 508, a blind spot detection sensor or camera 504 and a smart lens eyewear device integrated with the VCS. In at least one exemplary embodiment the smart lens eyewear can increase driver safety with features such as blind spot detection notifications and a vision system that can detect information beyond the range of visual perception 516. The driver's visual perception 514 may be limited by environmental factors such as weather, road, or traffic conditions. Another driver visual perception 514 limitations may be caused by late evening or night time driving. The forward facing camera 506 may include, but not limited to, radar, infrared camera or other optical instrumentation that allows images to be produced in all types of levels of light. The vision detection system 502 may send data to the VCS for processing of a graphical message sent to the smart lens eyewear device notifying the driver of objects during poor visibility. The vision detection system 502 may be able to detect objects where visibility is poor, and may send data to the VCS for processing messages for the smart lens eyewear to display transparent graphics of the unseen object. The blind spot detection 504 may alert the driver of a vehicle or object in the driver's blind spot while continuing to let the driver maintain line of sight on the road. The vision detection system 502 with blind spot detection 504 may increase vehicle safety while assisting the driver by providing additional information regarding the course of the road for display in the smart lens eyewear device.

As shown in FIG. 5, the vision detection system 502 may also assist with the navigation device to search for a requested street, address, highway number or business name by communicating this information to the VCS. The vision detection system 502 may improve navigation turn by turn direction with the use of the forward facing camera 506 exceeding visual perception. The VCS may process the data received from the visual detection system 502 and transmit additional navigation information to the smart lens eyewear device. The smart lens eyewear device will be able to display information received from the vision detection system 502 via the VCS while improving driver safety.

Another non-limiting embodiment in FIG. 5 is the use of the rear facing camera 508 within the vision detection system 502. The rear facing camera 508 may send information to the VCS for transmitting to the smart lens eyewear to assist the driver while in reverse gear to detect safety hazards and assist with parking lot maneuvers. The rear facing camera 508 may also calculate approaching vehicles and send information to the VCS to notify a driver of a vehicle that is approaching quickly upon them allowing for proactive measures, for example, switching over to a slower lane. The VCS may predict approaching vehicle location so that if the driver 510 decides to change lanes a warning message may be sent to the smart lens eyewear notifying the driving of a fast approaching vehicle in the lane they are moving into. The integration of a vision detection system 502 into the VCS with the smart lens eyewear may improve driver visibility of the road and elements around it.

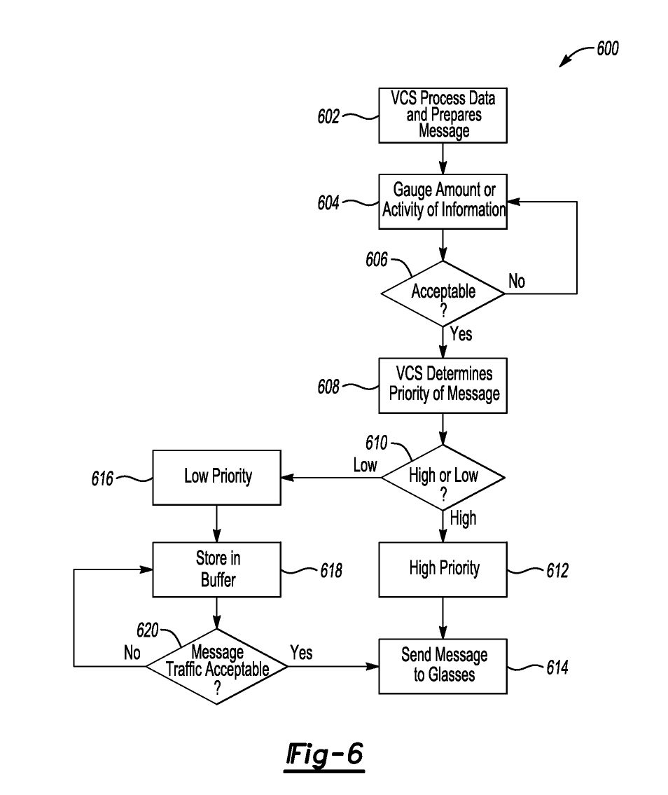

FIG. 6 is a flow-chart illustrating an exemplary method of priority level messaging 600 to be displayed on a smart lens eyewear device. In the VCS, multiple messages may be process and prepared 602 for transmitting at any given time, therefore it is import to gauge amount or activity of information 604 and limit the amount of messages being sent to a driver by determining priority 608 of a message. To determine when a message is to be sent for display by a smart lens eyewear device, the VCS may gauge amount or activity of information while ranking a message as a high or low priority level; giving safety messages the highest priority level. A non-limiting example of a low priority message would be to delay the display of a caller identification data message while storing the message in a buffer 618 until message traffic 620 to the smart lens eyewear device is acceptable. A high priority message may include, but not limited to, a vehicle diagnostic message or vision system hazard detection message, therefore the message may be displayed pending approval of the amount or activity of information 604 analysis.

At step 602, the VCS may process data and prepare messages 602 to be sent to the smart lens eyewear device. Once the messages have been prepared 602, the system may gauge amount or activity of information 604 by monitoring driver interface and activity with other devices connected to the VCS, including, but not limited to, nomadic devices, personal navigation device, visual front end interface and other adjusting input gauges available to the driver. The VCS may also look at the measurement sensor located on the smart lens eyewear to determine the driver's head orientation. If it is determined that it is not acceptable 606 to transmit the display, the system may continue to monitor amount or activity of information until it is acceptable for smart lens eyewear device to receive message from the VCS.

At step 608, once the VCS determines that amount or activity of information is acceptable 606, the VCS may analyze the graphic display message to the smart lens eyewear device and assign a priority level 610. The data may be associated with a priority assignment and based on that priority ranking may be stored in a buffer 618 or have a high priority level 612 assignment to be displayed preventing delay to the driver.

At step 616, if the data message assigned by the VCS has a low priority level assignment, the message may be stored in a buffer 618. While the low priority message is stored in a buffer 618, the system may monitor message traffic 620 and if acceptable the message may be displayed 614. The message being stored in a buffer 618, and message traffic monitoring 620 may be done by, but not limited to, the VCS, CAN Bus, or the smart lens eyewear device. Message communication between vehicle subsystems and devices may also be monitored by a vehicles controller area network and may assign priority of messages based on the importance of the communication to the driver.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A processor operably programmed and configured to:
receive information from one or more vehicle modules for display to a vehicle operator,
process the information into a format suitable for display to a driver on eyeglasses; and
communicate processed information to a transceiver for wireless communication to one or more eyeglasses for display thereon.

2. The processor of claim 1, wherein the processor additionally programmed and configured to limit an amount or activity of information displayed on one or more predefined thresholds.

3. The processor of claim 2, wherein the thresholds may be calibrated or selected by the driver.

4. The processor of claim 2, wherein the amount or activity of information may be measured based on a driver's use of a mobile device.

5. The processor of claim 4, wherein the mobile device includes a smart phone.

6. The processor of claim 1, wherein the processed information includes determining whether data may be given a high or low priority level.

7. The processor of claim 1, wherein the eyeglasses includes a smart-lens eyewear device.

8. The processor of claim 1, wherein the one or more vehicle modules includes a navigation device.

9. The processor of claim 1, wherein the processor is further configured to receive and analyze data from the eyeglasses.

10. The processor of claim 1, wherein the processed information includes displayable navigation instructions.

11. The processor of claim 1, wherein the processed information includes displayable local object augmentation data.

12. The processor of claim 1, wherein the processed information includes displayable vehicle proximity warning data.

13. The processor of claim 1, wherein the processed information is defined based on a user input interface configuring what information to receive and how.

14. A pair of eyeglasses comprising:
a processor;
a communications circuit within the processor for receiving and transmitting data to and from a vehicle computing system; and
one or more display elements configured to receive display information from the processor and to display the display information on the pair of eyeglasses.

15. The pair of eyeglasses of claim 14, wherein the processor is configured to measure driver's head orientation with an accelerometer, a magnetometer, or a gyroscope.

16. The pair of eyeglasses of claim 14, wherein the display information on the eyeglasses may be adjusted or limited with a user input interface.

17. A non-transitory computer-readable storage medium, storing instructions, which, when executed by a vehicle computing system, cause the system to perform a method comprising:
analyzing data from at least one vehicle subsystem;
preparing data based on analyzed vehicle subsystem data, prepared data including a representation to be displayed on one or more eyeglasses, and formatted as not significantly interfere with a driver's road-view; and
transmitting the data from a processor to the eyeglasses.

18. The computer-readable storage medium of claim 17, wherein the prepared data is made translucent so as not to significantly interfere with the driver's road-view.

19. The computer-readable storage medium of claim 17, wherein the prepared data is formatted to appear near an edge of a pair of eye glasses so as not to significantly interfere with the driver's road-view.

20. The computer-readable storage medium of claim 17, wherein the prepared data includes a virtual enhancement of a real world object, overlaid onto the real world object so as not to significantly interfere with a driver's road-view beyond any interference naturally provided by the object.
